(19) United States
(12) Patent Application Publication
(10) Pub. No.: US 2003/0014272 A1
(43) Pub. Date: Jan. 16, 2003

(54) E-audition for a musical work

(76) Inventors: Mary E. Goulet, Falls Church, VA (US); Robert Klein, Matthews, NC (US); Laura Harley, Alexandria, VA (US)

Correspondence Address: WORLDSAWAYMUSICAL.com, 7025-H Haycock Road, Falls Church, VA, 22043, US

(21) Appl. No.: 10/052,657

(22) Filed: Jan. 23, 2002

Related U.S. Application Data
(63) Continuation-in-part of application No. 09/902,769, filed on Jul. 12, 2001.

(51) Int. Cl. G06F 17/60

(52) U.S. Cl. 705/1

(57) ABSTRACT

Methods and products are provided to develop a musical work (such as a musical theater show, such as “Worlds Away”). On an Internet site, access to sheet music for the musical work is provided. Electronically recorded renditions of the musical work that are returned are posted on the Internet site as e-auditions to which website visitors may listen. Votes by website visitors on the e-auditions are received electronically.

### FIELD OF THE INVENTION

The invention generally relates to musical works, especially a new musical theatre show.

### BACKGROUND OF THE INVENTION

Historically, promoting new music and new musical works has been difficult and expensive. Establishing a base of paying customers for the music (and music-related products) continues to be a difficult, and often prohibitive, problem for musicians. Obtaining access to audiences historically has involved marketing, promotion, and distribution channels that do not necessarily open themselves to a new composer or musician who might be interested in using such existing channels.

At the same time that musicians want, and struggle, to reach and build audiences of interested, paying customers, for certain music and/or an upcoming event, there are individuals who may be interested but who are unaware of the music or event. Publicity for the music or the event may never have reached the individual. Or, in some cases, publicity may reach an individual but not catalyze a purchase, such as with conventional ticket sales systems that require physical visits to a sales location, or offer only limited telephone service hours.

The problems of audience-building, promotion, advertising and distribution are not limited to musicians, but also are faced by other creative artists, such as painters, writers, fashion designers, etc. New creative works face different and further challenges compared to many non-creative items. For example, a new contact lens cleaner may be promoted by giving away free initial samples, with the expectation of generating sales from the customer to whom the sample was given when the sample is completed. Music, art and literary works have not seemed to be particularly suited to such promotion techniques.

In recent years, musicians and others have come to post information about themselves and their work on the World Wide Web, or Internet, which in recent years has been increasing in popular usage, and offers a medium for musicians and non-musicians alike to inform potential customers about themselves, 24-hours-a-day. However, the Internet has been far from a perfect or complete solution to how musicians and artists may promote their new creative works and establish an audience, and actually has introduced certain problems, such as on-line unauthorized downloading of music that may erode paid purchases of creative work. Also, content on the Internet is vast, posting a website alone is unlikely to result in many, if any, website visitors. A new, unknown creative artist such as a musician who posts a website and merely waits for random searches is unlikely to be reached by many people. Existing options that exist for attracting visitors to a website either are not seen as particularly effective or generally are so costly as to make them impractical.

Conventional methods that have been used for promoting websites generally are not necessarily particularly well-suited to developing an audience for a new creative work. Various methods have been suggested. A first category of approach is advertising that publicizes the domain name without actually giving away anything. One example is traditional print advertising. Another example is domain name “car plates”, see www.domaim.com. That approach is relatively limited. Of the people seeing (or hearing) the domain name, few if any will be motivated to visit the site.

Business cards and paper literature on which a domain name appears generally receive notoriously little attention from the recipients.

Giveaways and gifts have been proposed on which a domain name is emblazoned, such as a coffee mug. Such a mug would be generally designed for in-person customer calls, one-on-one visits, drop-offs, trade-shows and the like. Mugs are favored giveaway items in charity gala and event take-home bags. Single give-away mugs are not particularly well-suited to being mailed.

From the perspective of the composing musician or other creative artist creating and/or developing a new musical work, the Internet's potential has not been realized.

### SUMMARY OF THE INVENTION

It therefore is an object of this invention to provide products and methods which exploit the advantageous features of an Internet website. The present invention provides for an Internet-based e-audition. Advantageously, an Internet-based e-audition can be used to establish contact with talented performers, control costs of developing a new musical production, publicize and promote the project, etc.

In order to accomplish these and other objects of the invention, the present invention in a preferred embodiment provides: an e-audition on the Internet for a musical work, the e-audition comprising: via an Internet website, access to music in written notation for which recorded versions of the sheet music are being or will be accepted by a developer of the musical work.

In another preferred embodiment, the invention provides: an e-audition on the Internet for a musical work, the e-audition comprising: on an Internet website, a plurality of posted e-audition songs and a voting counter.

Some particularly preferred inventive details, without the invention being limited thereto, are as follows. For the e-audition, the musical work may be a new musical theatre show under development and not yet performed live. The music in written notation may be sheet music printable onto paper by a website visitor; may comprise sheet music with words, etc. Optionally, when the sheet music prints onto paper, a restrictive legend may print behind the music and/or the website domain name may print onto the paper. The e-audition may include publicizing at least one address (such at least one address comprising an email address) to which may be sent a recorded version of the music to which access in written notation is provided.

The e-audition may include providing on the Internet site a form screen into which a submitter may type responsive information and to which form the submitter may attach a recorded electronic version of the music to which access in which notation was provided, said form when completed being electronically send-able to a receiving address for the developer of the musical work. The e-audition may include posting on the Internet site at least two audio-recorded e-audition songs each comprising a version of the music for which access was provided. The at least two posted e-audition songs may have been sent electronically via a submission form posted on the Internet website. E-audition songs preferably may be posted in order of submission with a most recently-received submission at the top. Next to a posted e-audition song preferably may be included public identifying information as specified by the submitter of the e-audition song.

The e-audition may include an automatic voting counter for the e-audition songs posted on the Internet site. When a voting counter is included, the voting counter may comprise identifying an email address that submitted a vote. In a particularly preferred embodiment of the e-audition, when a submitting email address submits a vote for a particular first e-audition song, the voting counter counts the vote unless and until the submitting email address votes for another second e-audition song, in which case the voting counter subtracts the vote by the submitting email address for the first e-audition song and counts the vote by the submitting email address for the second e-audition song. When voting is provided, the e-audition preferably includes a display of voting data, such as a display comprising a numerical-vote showing and/or a percentage-of-the-vote showing. The e-audition may include automatic un-posting, after a certain time period of being posted, of e-audition songs with relatively low total votes and/or relatively low percentage-of-the vote.

In another preferred embodiment, the present invention provides a method of promoting a creative work, comprising: for a to-be-promoted creative work, posting for public access an Internet site relating to the creative work; and after posting the site, optionally updating and/or revising the site one or more times; and, after posting the site, distributing a permanent non-paper announcement item for the site. In the inventive methods, preferably the announcement item is reusable. Also, it is preferred that the permanent announcement item is observable by others besides a person to whom the item was directly distributed. In a particularly preferred embodiment, the permanent non-paper announcement item may comprise a beach towel including the Internet site address.

Another preferred embodiment of the invention provides a creative-work promotional beach towel, comprising: a beach towel including an Internet domain name relating to a creative-work, wherein the name represents a publically accessible active Internet website on which appears content relating to the creative-work. For a beach towel according to the invention, preferably the Internet site address is embroidered onto the towel.

In the inventive methods and products, the creative-work may be musical, such as a musical theater show (which may be a new musical show). When the creative-work is musical, preferably the site includes, either as posted or as updated/revised, at least one musical sample clip.

In the inventive methods and products, preferably the site includes a purchasing feature. The purchasing feature may be for purchase of tickets to attend a performance (such as an upcoming new musical theater work) and/or for purchase of the creative-work.

### BRIEF DESCRIPTION OF THE DRAWINGS

The foregoing and other objects, aspects and advantages will be better understood from the following detailed description of the preferred embodiments of the invention with reference to the drawings, in which:

FIGS. 1(a) and (b) are schematics of creative-work promoting methods according to the present invention.

FIG. 2 is a top view of a beach towel according to the present invention.

FIGS. 3A and 3B are flow-charts for inventive e-auditioning in exemplary forms. FIG. 3C is a flow-chart for an exemplary voting scheme according to the present invention.

### DETAILED DESCRIPTION OF THE PREFERRED EMBODIMENTS OF THE INVENTION

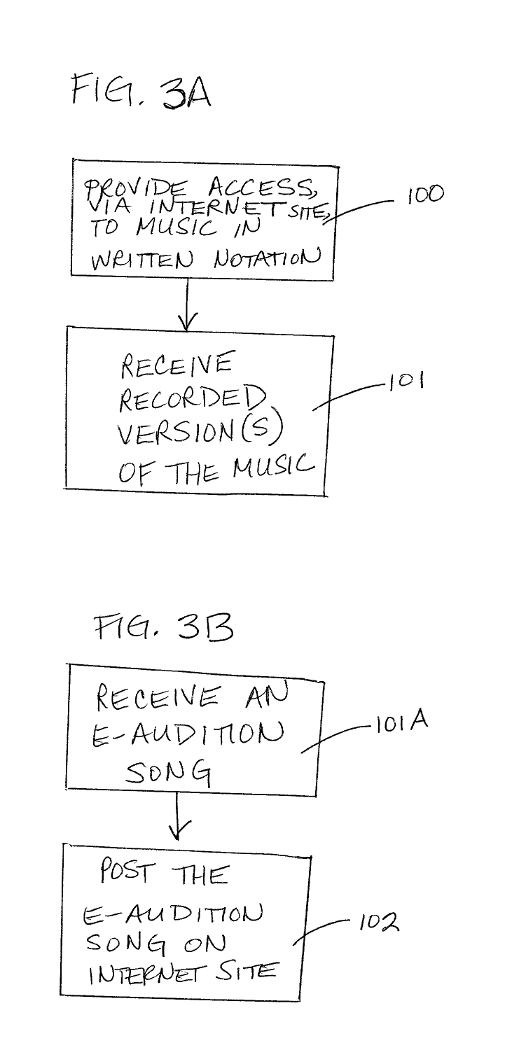

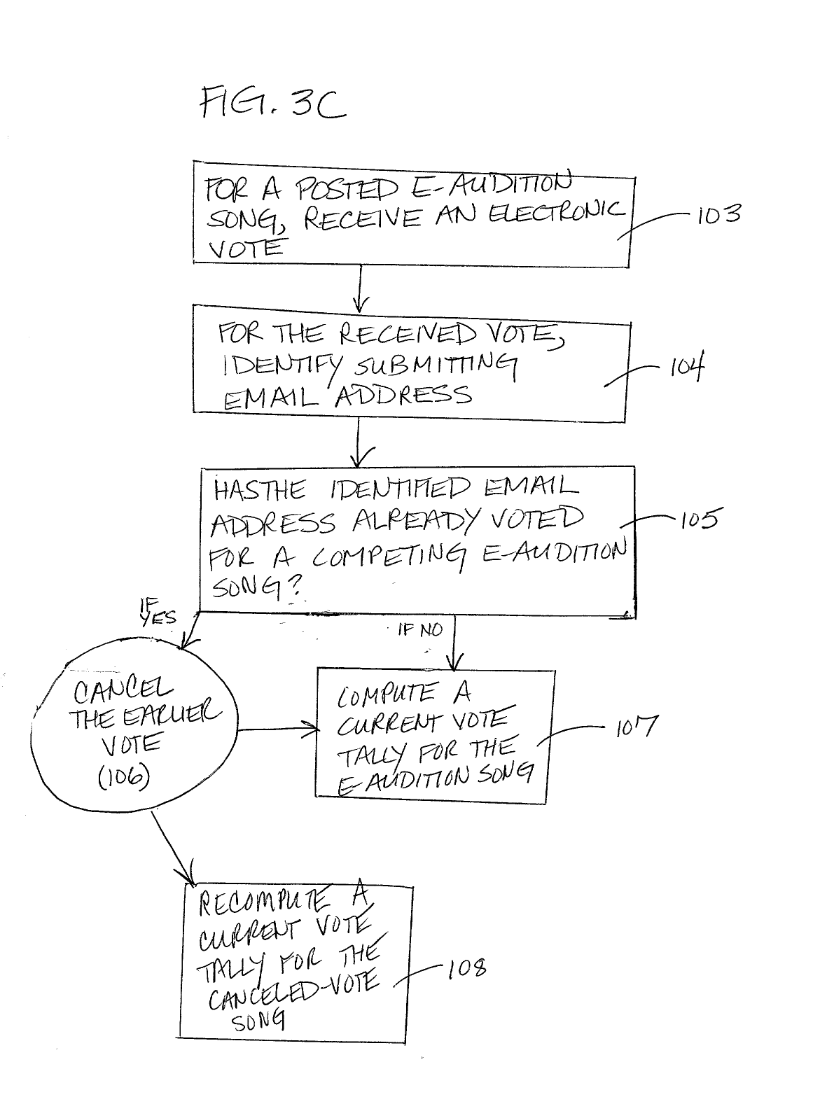

The present invention provides an Internet-based e-audition (i.e., an audition having at least one electronic component). As examples of an electronic component of an e-audition may be mentioned one or more of the following: making sheet music for a musical project available via an Internet website; electronic sending by a performer (such as a singer) of a computer-readable form of an audio version of sheet music for a musical project; electronic receiving by a developer of a musical project of a computer-readable form of an audio version of sheet music; posting an audio clip on an Internet website; and combinations thereof. An e-audition may intermix electronic and non-electronic components (such as a performer printing sheet music from an Internet website posted by a developer of a musical work, recording a CD audition version of the sheet music, and sending the CD via Federal Express to the developer of the musical work). An example of a preferred embodiment of the invention is seen with reference to FIG. 3A, in which an e-audition comprises providing access via an Internet site, to music in written notation (100) and receiving a recorded version(s) of the music (101). Another example of a preferred embodiment of the invention is seen with reference to FIG. 3B, in which an e-audition comprises receiving an e-audition song (101A) and positing the e-audition song on an Internet site (102).

A musical work as mentioned for the invention may be any musical work being developed, preferably a new musical work (such as a musical theatre show (such as “Worlds Away”), an opera, etc.).

As the Internet website in the present invention, there may be used an existing website or a website may be obtained and developed for the e-audition. Preferably, the website is one with a domain name that is strongly connected to the musical project (such as www.worldsawaymusical.com for the developing “Worlds Away” musical) and/or to the subject of auditioning (such as www.e-audition.com). Once a website is selected for the musical project and content posted to a first domain name, optionally one or more further domain names (such as advertising-friendly or publicity-friendly domain names) may be obtained and linked to the first domain name.

For initiating any audition, music is provided to the auditioning performer. In the present invention, access to music may be provided via the Internet website or the music may be provided otherwise (such as by U.S. mailing the sheet music upon request), most preferably with access to the music being provided via the Internet website). When the music in written notation is provided via the Internet, preferably the music is sheet music printable onto paper by a website visitor. Optionally, when the sheet music prints onto paper, a restrictive legend (such as “Do not copy” or “Copyrighted, photocopies unauthorized”) prints behind the music, and/or the website domain name prints (such as in a frame around the music) onto the paper.

An auditioning performer optionally may record a CD or other computer-readable audition song, a tape, or other audio recording, and send his or her recording to an address as directed by the Internet site. Preferably, instructions are provided on the Internet site for what format the auditioning performer should use to ensure compatibility. Most preferably, an auditioning performer records a computer-readable, electronically transmissible audio version according to the instructions and emails the audio version to an email address as directed on the Internet website. For facilitating such email submissions, the Internet website preferably includes a form screen into which a submitter may type responsive information (e.g., his/her name to be used for publicly describing the submitted audio; his/her contact information to be used by the music developer but not to be published; etc.), to which form the submitter may attach a recorded electronic version of the music being auditioned.

As submissions are received, they may be checked for compatibility and suitability for posting on the Internet site. E-audition songs may be posted upon confirming their compatibility and suitability for posting, or may be batched and held (such as if a date for posting and voting has been particularly announced).

The invention provides, in a particularly preferred feature of the e-audition, for voting by site visitors on posted e-audition songs. It will be appreciated that an automated voting system is highly preferred. An automatic voting counter may be provided, whereby when a site visitor votes “for” an e-audition song that he or she likes, the vote is captured and stored by an identifying features (such as email address of the voter). From the votes, data may be generated including total number of voters, total of votes for a particular e-audition song, percentage-of-the-vote for a particular e-audition song, etc.

It will be appreciated that one or more voting control systems will be desirable, such as a voting control system that limits voting, such as limiting a voter to voting on one e-audition song during a specified time period (such as the entire open voting period, monthly, weekly, daily, etc.). For example, there may be mentioned a voting control system in which, when a submitting email address submits a vote for a particular first e-audition song, the voting counter counts the vote unless and until the submitting email address votes for another second e-audition song, in which case the voting counter subtracts the vote by the submitting email address for the first e-audition song and counts the vote by the submitting email address for the second e-audition song.

Another exemplary voting control system is shown with reference to FIG. 3C. For a posted e-audition song, an electronic vote is received (103). For the received vote, the submitting email address is identified (104). The query is made whether the identified submitting email address already has voted for a competing e-audition song (105). If not, a current vote tally for the e-audition song is computed (107); but if so, the earlier vote is cancelled (106), a current vote tally for the cancelled-vote song is recomputed (108) and a current vote tally for the e-audition song is computed (107).

The present invention in a particularly preferred embodiment provides an e-audition on the Internet for a musical work, the e-audition comprising a plurality of posted e-audition songs and a voting counter. When a voting counter is included, it is particularly preferred to further include a posted display of voting data (such as, for an e-audition song, a numerical-vote showing and/or a percentage-of-the-vote showing).

It will be appreciated that the number and arrangement of posted e-audition songs could benefit from controlling and established order. There may be included an automatic un-posting system, wherein after a certain time period (e.g., 1 month, 2 months, etc.) of being posted, e-audition songs with relatively low total votes and/or relatively low percentage-of-the vote are removed from the Internet site. For determining order of appearance of posted e-audition songs, there may be applied a rule (such as leading with a most recently-received e-audition song at the top, leading with a highest-vote-getting e-audition song, etc.).

It will be appreciated that, once e-audition songs are posted on the Internet website for a new musical work, the enhanced content of the website may better support other promotional and development efforts for the musical work. For developing the Internet website, as well as for developing and promoting the musical work underlying the Internet website, one or more of the following inventive methods, systems and products (such as domain-name beach towels) for promoting a creative work may be incorporated.

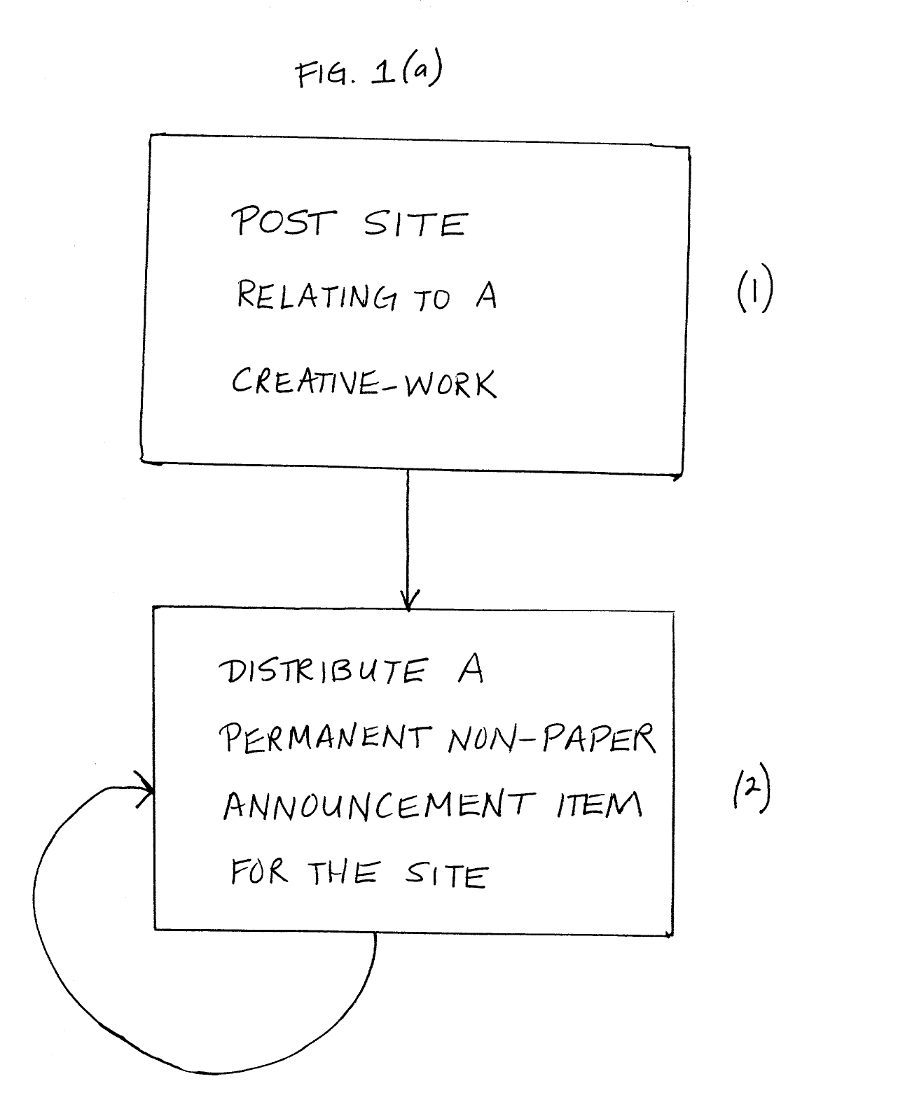

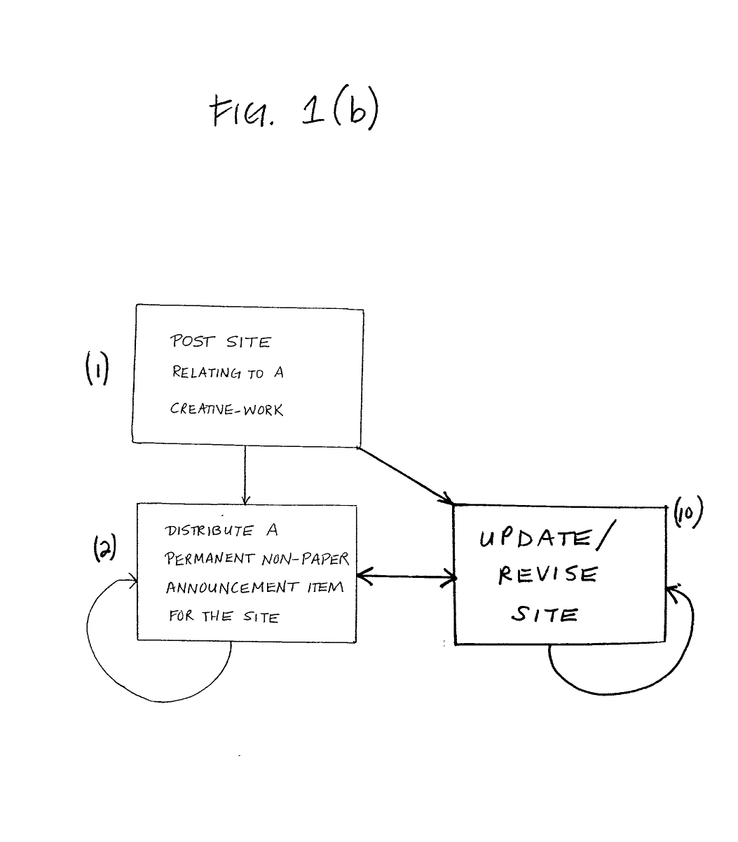

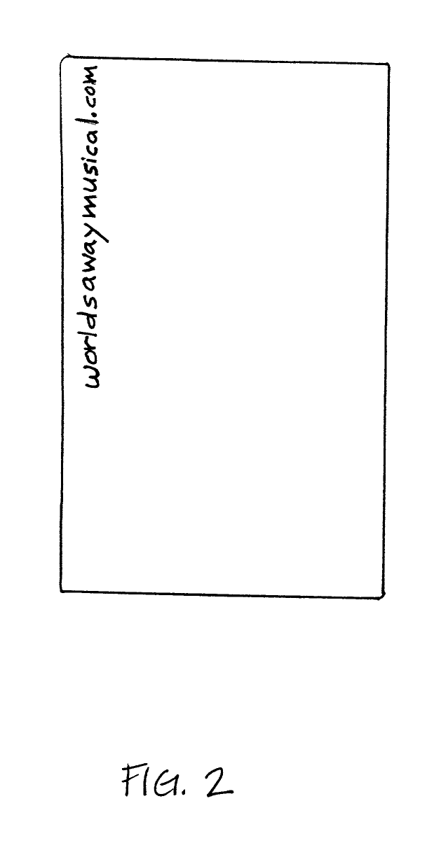

In preferred embodiments, such as those shown in FIGS. 1(a) and 1(b), the invention provides methods of promoting a creative work. A creative work to be promoted may be, without limitation, any musical work (such as a song, a musical theater show, etc.), any literary work (such as a book, etc.), any dramatic work (such as a play, etc.), any artistic work (such as a painting, a painting style, etc.). A creative work includes single works (such as a musical theater show, a song, an album, etc.) and series (such as songs or albums by the same composer).

As shown in FIG. 1, such an inventive method preferably includes, for a to-be-promoted creative work, posting for public access an Internet site relating to the creative work (1). Preferably the domain name relates closely to the to-be-promoted creative work, and is easy to remember. Also preferably the domain name avoids character combinations that when viewed in print or other visible form may be difficult to discern or reproduce (e.g., substituting a zero for a letter “O” in a word, such as “w0rd”; difficult-to-spell words; long strings of characters that do not spell a word).

As shown in FIG. 1, the inventive method provides for, after posting the site, distributing a permanent non-paper announcement item for the site (2). A permanent non-paper announcement item according to the invention includes any non-paper item intended for more than a single use, such as a beach towel, ceramic mug, luggage, article of clothing, jewelry, accessory, sunglasses, hat, etc., on which is included the Internet site address. Preferably, the permanent announcement item is observable by others besides a person to whom the item was directly distributed. Where the permanent announcement item comprises a towel or clothing, most preferably, the Internet site address is embroidered onto the towel for greater permanence.

In the case of a creative work that is a show (such as a musical theater show), which may spend years in development and which, once staged, generally is in a limited geographic area at one time, the permanent announcement item is particularly preferred to be an item which the user will keep for several years. Thus, the user is reminded from time to time to refer back to the website and can be updated about the show. For a show, preferably the website as posted or as revised includes a ticket purchasing feature.

It will be appreciated that distribution of a permanent announcement item as provided by the invention does not exclude the additional distribution of other announcement items, such as nonpermanent paper announcement items. Preferably, non-permanent announcement items (such as business cards, invitations, stationery, note cards, balloons, etc.) are used in addition to the permanent announcement items.

With reference to Figure 1(b), in an exemplary embodiment of the invention, the inventive method of FIG. 1(a) further includes, after posting the site, updating and/or revising the site one or more times (10). Such updating and/or revising of the site preferably includes changes and additions designed to provide new material of interest to returning site visitors. Preferably, the site updating and/or revising occurs more frequently than semi-annually, and more preferably, more frequently than quarterly, with updating as often as possible (such as weekly) being most preferred.

Where the creative work is musical (such as a musical theater show or a song), optionally, the site includes, either as posted or as updated/revised, at least one musical sample clip. Including a musical sample clip is preferred, but not required. As a sample clip, preferably less than an entire song is used, such as the first 30 seconds. Preferably the entire song is not used as the sample clip, since some visitors may download the musical sample and including the entire song may be more likely to interfere with achieving paid sales. Where a sample clip is included, the site may include a statement informing someone listening to the sample clip how to find a full recorded version and/or a full live version. Also, the site may includes a statement that the musical sample clip due to equipment and/or system constraints is of somewhat compromised quality compared to the full recorded version and/or the full live version. When a musical sample clip is included on the site, preferably the inventive method includes filing a copyright application relating to the musical sample clip before the musical sample clip is included on the site.

In another aspect of the invention, where the creative work being announced is a new musical, members of a target audience (such as persons associated with the press, singers, dancers, musicians, theater and music personnel, music directors, potential investors, agents, ticket sales businesses, radio stations, theater-goers, attendees at a charity gala, etc.) are provided with a relatively permanent tangible object (such as a game, bookmark, etc.) that promotes the musical and/or familiarizes the target audience with at least some of the substance of the musical (such as at least one character, setting, scene, storyline, etc., time period of the action, etc.). Such tangible objects related to the musical may (and preferably do) have marked thereon mention of a website associated with the new musical.

The invention advantageously provides for give-away items that preferably are related to the new creative work without the give-away items themselves being some or all of the new creative work (e.g., not CDs, tapes).

The present invention also provides for advantageous methods of distributing tangible objects (such as beach towels, games, bookmarks, etc.), in which a distribution mechanism is selected based on a balancing of how desirable or intriguing the object is thought to be when mentioned or offered to a potential recipient (e.g., “Email us for a free Worlds Away beach towel”, “Email us for a free bookmark”, “email us for a free mug”, etc.), cost of the object, cost of carrying out the particular sending or delivery option (e.g., cost of packaging materials, postage), and value to be obtained from getting the object into the possession of the intended recipient (e.g., durability of the object, likelihood that the recipient will be impressed by or like the object, length of time that the recipient will keep the object before discarding, etc.). A particularly preferred distribution mechanism comprises selecting an object that a potential recipient is relatively likely to want (such as a beach towel as contrasted with a plastic cup) and communicating (such as by U.S. mail, email, etc.) with the potential recipient to advise that the free give-away item is available by e-mailing via the website for the new creative work. Such a distribution mechanism minimizes the number of objects sent to individuals who are no longer at the mailing address or may be not particularly interested in the give-away item or the creative work itself and thus is particularly advantageous for controlling expenditures. Where an individual is no longer at the address to which U.S. mail is sent, it is less costly to have a returned letter or postcard rather than a returned package. Advantageously, the mentioned distribution mechanism increases the number of people who actually visit the website for the new creative work. Thus, it is particularly preferable that before advising that the free give-away item is available via the website, that the website be posted with substantial content (such as information about the new creative work, and, in the case of a new musical work, at least one song clip and/or an e-audition song preferably are posted).

For identifying potential recipients who are involved with theater and/or music, as sources that may be consulted there may be mentioned Yellow Pages telephone directory, newsletters (such as performing arts organization newsletters), newspapers, magazines, etc. It is preferred that the more costly the give-away item is, the more care that is selected in targeting individuals to whom the give-away item is offered.

In addition to the direct distribution mechanisms mentioned above, indirect distribution mechanisms also may be used, where the give-away items are provided (preferably in a batch) to someone other than the ultimate recipient, who in most cases is unknown. An exemplary indirect distribution mechanism is to provide tangible objects promoting the new creative work to charitable organizations for use as door-prizes, in take-home bags, or as auction items. Such an indirect distribution mechanism may minimize distribution costs, by substituting drop-off or shipping of a batch of items for costly separate item-by-item mailing. In the case of gala take-home gift bags, in place of the actual announcement item itself, there may be substituted a certificate for the item, such as a certificate that advises that the attendee may receive a free beach towel by e-mailing via the website for the new creative work. For controlling and managing the response, each certificate may be separately reference-numbered.

As for the website used in the present invention, it will be appreciated that an initially-posted website most preferably is developed and expanded from time-to-time. The exact selection of announcement items, timing of offering announcement items, and identification of individuals to whom the announcement items are offered are not fixed and may be based on balancing website development costs, promotional announcement item costs, direct costs of developing the new creative work, etc. Preferably announcement items are not provided to outsiders until the website has reached a minimal level of appeal and interest to a viewer. However, it is not necessary for sending permanent announcement items that the website be completely polished or that the creative work be fully developed or at a certain point far into its development. A permanent announcement item according to the invention is believed to be retained by a recipient in his/her possession longer than a paper or other disposable or impermanent announcement item and thus make the address of the website available if the visitor should want to follow the progress of the new creative work. For example, an early recipient of a permanent announcement item may first access the website at a relatively early time (such as before tickets for any show are on sale, before the first live performance of a musical show, before a DVD of the musical show has been recorded and offered for sale, etc.) and, at a later time (such as in 6 months, a year, or 1 ½years, or 2 years, etc.), the early visitor may return to the website and find further features (such as sheet music to print for e-auditioning, posted e-auditions songs to which to listen, tickets being available to purchase for a live performance of the show, bus tours and travel packages available comprising seeing the show, availability of a DVD for purchase, a zip-code feature where the visitor can enter his/her zip-code and receive an automatic response listing when, if any, upcoming performance(s) of the show are scheduled in his/her geographic area, etc.)

### EXAMPLE 1

For a new musical, “Worlds Away”, the domain name http://www.worldsawaymusical.com was obtained from Network Solutions Inc. A first-version website with text was posted to the public, and subsequently revised and updated, such as by changing the graphics, adding pages, including pictures, including information about upcoming activity, including information about where to purchase a CD, etc. After the http://www.worldsawaymusical.com website went on line, beach towels were made (by High Peak Sportswear, Lynchburg, Va.) on which were printed worldsawaymusical.com. The worldsawaymusical.com beach towels were distributed to attendees at a CD release party, buyers at record stores, radio stations, store owners, theater personnel, and others.

### EXAMPLE 2

For the new “Worlds Away” musical of Example 1, a “contact us” screen and function was established on the worldsawaymusical.com website. Sample clips of songs (for which copyright applications had been filed) were included on the worldsawaymusical.com website. Written material was sent (such as by U.S. postal mail) advising recipients that they could get a free “Worlds Away” beach towel by emailing worldsawaymusical.com. Email responses via the worldsawaymusical.com website were received, such as from radio stations, and beach towels were sent to the requesters. Thus, the requesters were introduced to the worldsawaymusical.com website and to the tunes from the upcoming “Worlds Away” musical.

### EXAMPLE 3A

A print advertisement is placed in which the question is posed, “What is the name of the new science fantasy musical?” and space for an answer is given, “WO___ S A___”. It further is stated: “Email via the website www.WO ___ SA___ musical.com for your FREE beach towel.”

### EXAMPLE 3B

Radio stations are advised that a free beach towel is available to the first of a particular number (such as 10) of their listeners that can identify the name of the new science fantasy musical, and respond by email by taking the name of the new musical (no spaces) followed by the word “musical” (no spaces) “dot com”. They are also advised that, as a clue, the name is two words, and that as a further clue, the first word is six letters starting with “W” and the second word is four letters starting with “A”.

While the invention has been described in terms of its preferred embodiments, those skilled in the art will recognize that the invention can be practiced with modification within the spirit and scope of the appended claims.

We claim:

1. An e-audition on the Internet for a musical work, the e-audition comprising: via an Internet website, access to music in written notation for which recorded versions of the sheet music are being or will be accepted by a developer of the musical work.

1. The e-audition of claim 1, wherein the musical work is a new musical theatre show under development and not yet performed live.

2. The e-audition of claim 1, wherein the music in written notation is sheet music printable onto paper by a website visitor.

3. The e-audition of claim 3, wherein when the sheet music prints onto paper, a restrictive legend prints behind the music.

4. The e-audition of claim 3, wherein when the sheet music prints onto paper, the website domain name is printed onto the paper.

5. The e-audition of claim 1, including publicizing at least one address to which may be sent a recorded version of the music to which access in written notation is provided.

6. The e-audition of claim 6, wherein the at least one publicized address comprises an email address.

7. The e-audition of claim 1, including providing on the Internet site a form screen into which a submitter may type responsive information and to which form the submitter may attach a recorded electronic version of the music to which access in which notation was provided, said form when completed being electronically send-able to a receiving address for the developer of the musical work.

8. The e-audition of claim 1, wherein the music in written notation comprises sheet music with words.

9. The e-audition of claim 1, including posting on the Internet site at least two audio-recorded e-audition songs each comprising a version of the music for which access was provided.

10. The e-audition of claim 10, wherein the at least two posted e-audition songs were sent electronically via a submission form posted on the Internet website.

11. The e-audition of claim 10, including an automatic voting counter for the e-audition songs posted on the Internet site.

12. The e-audition of claim 12, wherein the voting counter comprises identifying an email address that submitted a vote.

13. The e-audition of claim 13, wherein, when a submitting email address submits a vote for a particular first e-audition song, the voting counter counts the vote unless and until the submitting email address votes for another second e-audition song, in which case the voting counter subtracts the vote by the submitting email address for the first e-audition song and counts the vote by the submitting email address for the second e-audition song.

14. An e-audition on the Internet for a musical work, the e-audition comprising: on an Internet website, a plurality of posted e-audition songs and a voting counter.

15. The e-audition of claim 15, including a display of voting data.

16. The e-audition of claim 16, wherein the display for an e-audition song comprises a numerical-vote showing and/or a percentage-of-the-vote showing.

17. The e-audition of claim 15, including automatic un-posting, after a certain time period of being posted, of e-audition songs with relatively low total votes and/or relatively low percentage-of-the vote.

18. The e-audition of claim 15, including posting e-audition songs in order of submission with a most recently-received submission at the top.

20. The e-audition of claim 15, including, next to a posted e-audition song, public identifying information as specified by the submitter of the e-audition song.
